(19) United States
(12) Patent Application Publication
(10) Pub. No.: US 2010/0242539 A1
(43) Pub. Date: Sep. 30, 2010

(54) Decorative eyelid covering and process

(76) Inventor: Shannon Maxey, Virginia Beach, VA (US)

Correspondence Address: Bradley D. Goldizen, HC 80 BOX 261, Maysville, WV, 26833, US

(21) Appl. No.: 12/383,672

(22) Filed: Mar. 26, 2009

(51) Int. Cl. A44C 25/00; B32B 38/00

(52) U.S. Cl. 63/14.9; 156/256

(57) ABSTRACT

A flexible eyelid cover includes an adhesive having a decorative design arranged opposite an inner surface of the flexible eyelid cover. The cover is formed from wig adhesive and adheres to an upper eyelid of a wearer. An upper edge of the cover is convex in shape. A lower edge of the cover includes a first curved surface and a second curved surface. The second curved surface is concave in shape and arranged on a region of the upper eyelid distal from the nose. Various designs and ornaments may be adhered to outer surface of the cover.

There are no related patent applications.

The present application was not subject to federal research and/or development funding.

### TECHNICAL FIELD

Generally, the present invention relates to a decorative device attached to an upper eyelid of a wearer. More particularly, the device is a uniquely shaped strip of adhesive, such as wig adhesive, that is formed to comfortably and safely be worn on an upper eyelid of the wearer without creating any discomfort to the wearer. The adhesive is preferably clear or flesh colored. The device may be individualized by the wearer to be easily conformed to a uniquely shaped eyelid of the wearer. The process includes creating a unique decoration on one side of a strip of adhesive and thereafter applying the opposite side to a wearer's eyelid

### BACKGROUND OF THE INVENTION

Decorating the human body has been commonplace in most human cultures for thousands of years. Primitive societies adorned their bodies with the use of stains from colored plants, clays and ash. There are a variety of ornamental coatings and devices for adorning or decorating the body. For example, permanent and temporary tattoos have been used as decorations for many centuries. Still others have constructed and used transferable dye images, painted images, and decal images.

A painted image on an eyelid requires much artistic effort of a painter or makeup artist to create a quality image. The cost of creating such quality images is very expensive because of the amount of time expended by the artist in creating the image. Thus, it is cost prohibitive for many folks to utilize the professional services of a painter or makeup artist in creating an eyelid covering.

Other eyelid covering include powdered or liquid dyes that are applied to one's eyelid. Transferable dyes or makeup are relatively inexpensive and brushed onto the eyelid of a wearer via an applicator or brush. These dyes or makeup are generic and fail to be unique to an individual. Moreover, much of the dye or makeup is water-soluble. When worn during pageants or in areas of higher temperatures, these dyes or makeup runs and streaks.

By way of example, there are several products that have previously been used to decorate an eyelid. One such product is eye shadow which is brushed onto or applied to the eyelid through an oil-based makeup transfer. U.S. Pat. No. 6,472,039 discloses an applique for application to a body part such as the fingernail. The applique comprises a thin flexible film having an array of decorative stones or gems adhesively secured on the upper surface with the bottom surface having a self-adhesive layer. U.S. Pat. Appl. Pub. US 2006/0188553 A1 shows an eyeliner element adapted to be applied to a lower portion of an upper eyelid, and an under eye concealer element adapted to be applied to an upper portion of a lower eyelid each include a thin film substrate, an adhesive layer, and a coloring layer formed opposite the adhesive layer.

None of the prior art discloses an eyelid covering affixed to an upper portion of an eyelid which is removable and reusable as in the present invention. Thus, the prior art suffers from many problems as identified above. It is an aim of the present invention to overcome these problems to provide a novel eyelid decoration which is inexpensive and requires little application time.

### SUMMARY OF THE INVENTION

The device of the present invention is an uniquely shaped strip of adhesive having an exterior surface that includes one or more decorations that essentially consist of glitter, foil, paper, rhinestones, synthetic or genuine gems, stones, crystals, plastic, metal and acrylic decorative items and feathers and is placed onto an eyelid of a wearer. Typically, the device ranges from one to three inches in width and may be provided in a variety of irregular shapes. Preferably, the adhesive is a type that is suitable for use in attaching a toupee or wig securely to a head and is moisture resistant.

It is an object of the invention to teach a unique device to be applied to the eyelid of the wearer and worn for performance and beauty enhancement.

It is a further object of the invention to disclose a device that allows non creative wearers to wear professionally designed pieces of art work that typically take many hours to be applied by a professional fashion designer or makeup artist.

It is a further object of the invention to teach a device and method that allows a wearer to construct or form a particular design or shape of an eyeliner device and thereafter apply said device to an eyelid to reduce the overall amount of hours necessary for creating a unique eyelid device.

It is an additional object of the invention to reduce an amount of time necessary for creating a unique eyeliner by alleviating the necessity of spending several hours in a makeup chair.

It is a further object of the invention to teach a unique eyelid overlay device that is provided in many designs and in a variety of different colors, materials and art work.

It is another object of the invention to teach an eyelid overlay device that may be utilized by performers, dancers, cheerleaders, pageant contestants, bartenders, or any other who is looking to enhance the beauty of the face.

Further objects, features and advantages of the invention will become apparent from a consideration of the following description and the included claims when taken in connection with the previous discussion and the accompanying drawings. The above explanations are provided to illustrate the utility of the invention. And, by no means necessary are these explanations intended to limit the application of this invention from being used for other purposes.

### BRIEF DESCRIPTION OF THE DRAWINGS

FIG. 1A is a plan view of a preferred embodiment of the invention and showing the unique shape of the adhesive from the front.

FIG. 1B is an elevated back view of the preferred embodiment shown in FIG. 1A.

FIG. 1C is an elevated side view of the invention.

FIG. 1D shows the invention applied above the eye of a wearer.

FIG. 2A represents the various parts of the upper eyelid.

FIG. 2B shows the invention arranged atop an upper eyelid.

FIG. 3A is a front view of a first embodiment with a plurality of beads arranged on upper and outer edges of the invention. FIG. 3B is a back view of FIG. 3A.

FIG. 4A is a front view of a second embodiment with a plurality of beads arranged on upper and outer edges of the invention. FIG. 4B is a back view of FIG. 4A.

FIG. 5A is a front view of a third embodiment with a plurality of beads arranged on upper and outer edges of the invention. FIG. 5B is a back view of FIG. 5A.

FIG. 6A is a front view of a fourth embodiment with a plurality of beads arranged on upper and outer edges of the invention. FIG. 6B is a back view of FIG. 6A.

FIG. 7A is a front view of a fifth embodiment with a plurality of beads arranged on upper and outer edges of the invention. FIG. 7B is a back view of FIG. 7A.

FIG. 8A is a front view of a sixth embodiment with a plurality of beads arranged on upper and outer edges of the invention. FIG. 8B is a back view of FIG. 8A.

FIG. 9A is a front view of a seventh embodiment with a plurality of beads arranged on upper and outer edges of the invention. FIG. 9B is a back view of FIG. 9A.

FIG. 10A is a front view of an eighth embodiment with a plurality of beads arranged on upper and outer edges of the invention. FIG. 10B is a back view of FIG. 10A.

FIG. 11A is a front view of a ninth embodiment with a plurality of beads arranged on upper and outer edges of the invention. FIG. 11B is a back view of FIG. 11A.

FIG. 12A is a front view of a tenth embodiment with a plurality of beads arranged on upper and outer edges of the invention. FIG. 12B is a back view of FIG. 12A.

### DETAILED DESCRIPTION OF THE INVENTION

The following is the preferred embodiment or best mode for carrying out the invention. It should be noted that this invention is not limited by the discussion of the various embodiments and should only be defined by the appended claims. Moreover, it should be recognized that this invention is not limited by the discussion of the preferred embodiments, but that skilled artisans may easily recognize that certain modifications may be made without deviating from the spirit of the invention.

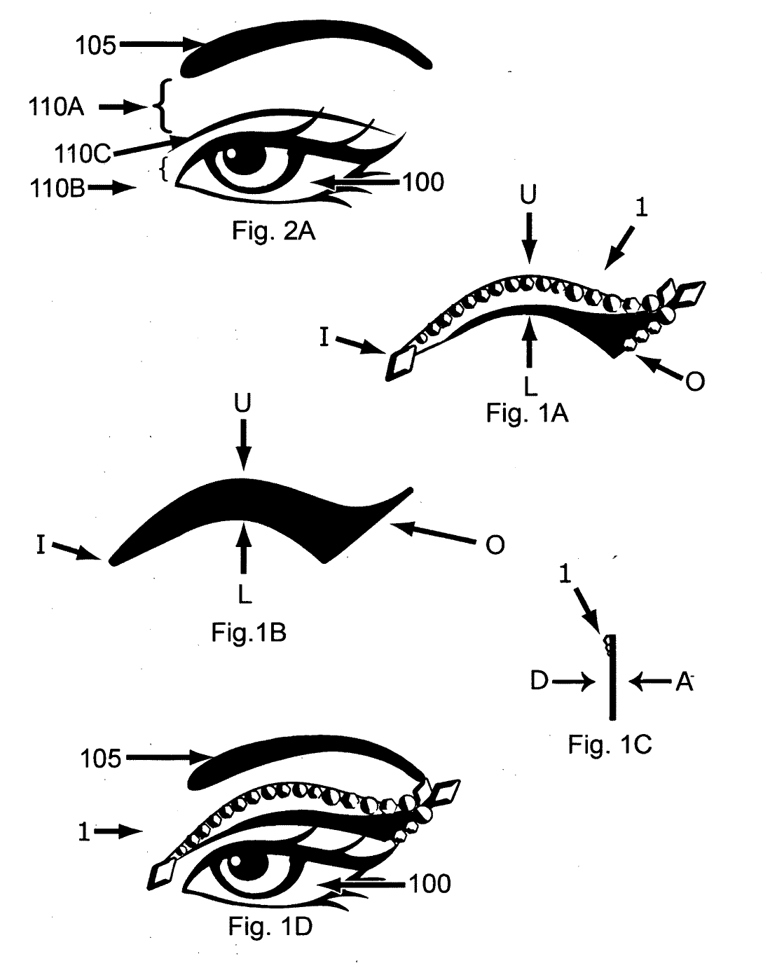

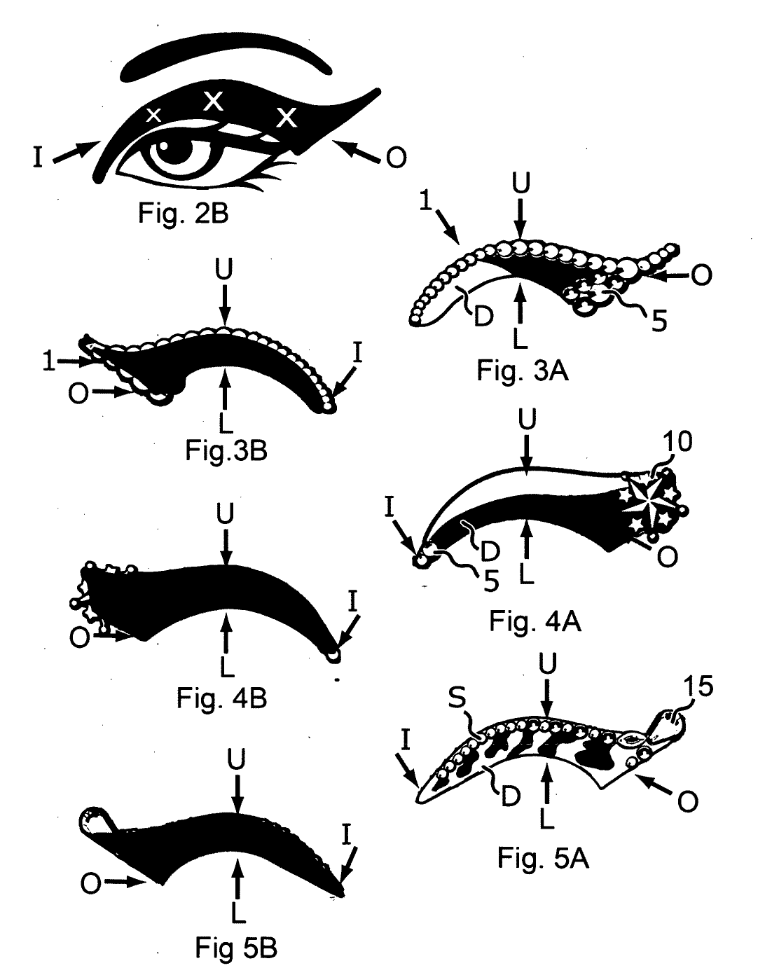

FIGS. 1A-1D shows a first embodiment of the invention. A decorative eyelid covering 1 is arranged atop an eyelid as shown in FIGS. 1D and 2B where “X”s provided on the decorative side of the adhesive denotes three-dimensional ornaments as discussed hereinafter with respect to the additional embodiments. For ease in understanding the novelty of the invention, the terms defining the decorative eyelid covering are oriented with respect to a device worn by a user. The decorative eyelid covering is preferably formed from sheet adhesive used in securing wigs to wig wearers' heads. The adhesive may be provided in a thickness of up to several mils. The adhesive is water resistant, may comprise openings for allowing perspiration to evaporate there through, and reusable. In this manner, the device is more economical for use and ecologically friendlier to the environment.

The eyelid covering 1 includes an upper edge “U”, a lower edge “L”, an inside edge “I” and an outside edge “O”. An exposed front side “D” is decorated with various printed designs or ornaments. A back side “A” adheres to an upper portion of an eyelid 110A as shown in FIG. 1D. In FIGS. 1A and 1D, the decorative side D includes a printed pattern and small glass or plastic beads or other such ornaments having various geometric shapes such as circles, octagons, diamonds and etc. The printed pattern is provided substantially on the exposed surface D and formed in a pair of succeeding layers as shown. Each layer may contain a particular color or hue of a color. In this instance, diamond shaped ornaments are arranged at the inner edge I and an angle where the outside edge O intersects the upper edge U. Moreover, the upper edge U is formed to include both a convex portion and a concave portion arranged against one another. Lower edge L is formed in a concave shape with one end thereof intersecting an end of the convex portion of the upper edge U to form an angle that is preferably 22.5 degrees or less. The opposite end of the lower edge intersects a lower end of outside edge O to form a second angle which is greater than ninety degrees. An upper end of outside edge O intersects an end of the concave portion of upper edge U to form a third angle.

FIG. 2A shows various facial features and the proper placement of the invention. An eyebrow 105 is arranged atop an eyelid which comprises an upper region 110A. A crease 110C defines a separation between the upper region 110A and lower region 110B of the eyelid which sits above and atop the eye 100. As can be understood by FIG. 2B, the eyelid covering 1 is fastened to the upper region 110A of the eyelid and extends downward on its inside edge I towards where the eyelid intersects the nose. In this manner, the eyelid covering is arranged atop a nonmoving portion of the eyelid to prevent the covering 1 from being dislodged during blinking action by the wearer. In the preferred embodiment, the device includes a flesh colored or clear water resistant, adhesive strip. As can be understood by the drawings, the device 1 is arranged above eye 100 on the upper eyelid 110A such that the first angle is substantially near the wearer's nose.

FIGS. 3A-3B show an additional embodiment of the invention wherein lower edge L has a smaller radius of curvature than the lower edge L shown in FIGS. 1A-1B. An intersection angle defined between the outside edge O and the upper edge U is rounded as shown. In FIGS. 3A-3B, the outside edge O is also shorter than that of FIGS. 1A-1B. Sequins 5 are arranged along the upper edge U and outer edge O and fastened thereto via the adhesive properties of the strip of adhesive that forms the decorative eyelid covering 1. A printed pattern is provide on the decorative side D such that two different colors divide it.

FIGS. 4A-4B include an outer edge that comprises a fourth angle and having a plurality of star ornaments 10 provided substantially along the outer edge O of the device 1. Sequins are arranged along the inner surface of the device 1. The printed pattern may divide the decorative side as shown.

FIGS. 5A-5B show an additional embodiment wherein the intersection region between the upper edge U and the outside edge O is a sharp angle. The radius of curvature is sharper for the lower edge L. Sequins and tear dropped shaped ornaments 15 are provided along the upper and outer edges of the device 1. A printed pattern on the decorative side D of the device 1 is spotted.

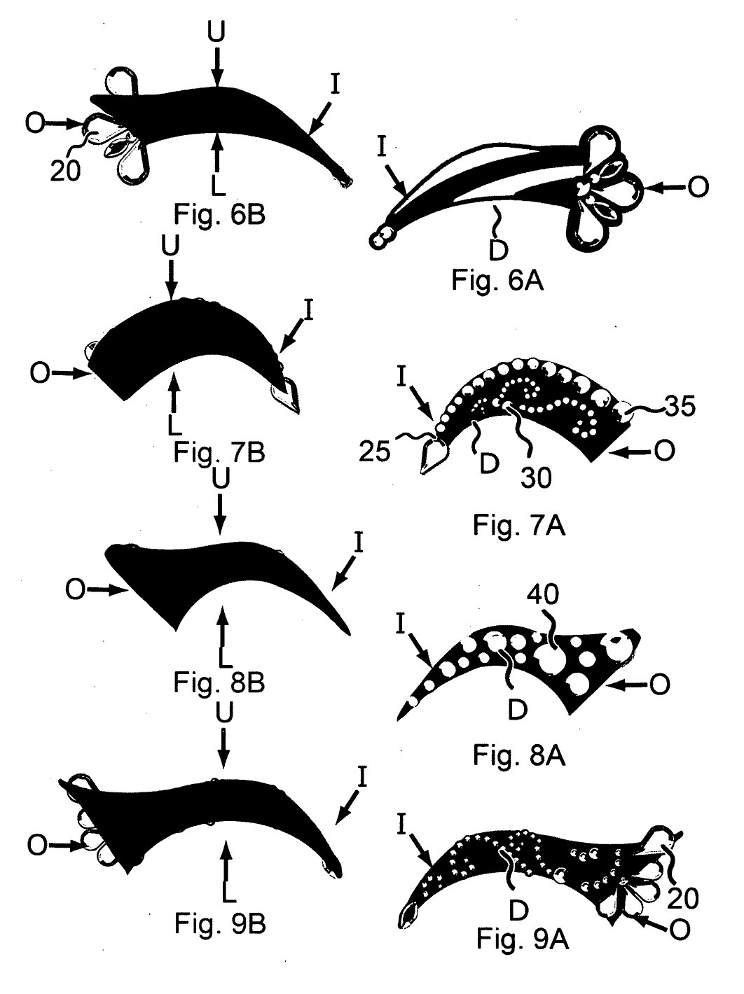

FIGS. 6A-6B depict a further embodiment of the invention wherein the radius of curvature is greater along the lower edge L than in previous embodiments. The printed pattern is shown as strips extending from the outside edge O towards the inside edge E. Ornaments 20 and sequins are arranged as shown.

FIGS. 7A-7B show an additional embodiment of the invention wherein the overall distance between the inside edge I and outside edge O is shorter than in previous embodiments. The outside edge O forms a ninety degree angle to the lower edge L in this instance. Certain embellishments 35 are provided on the decorative side D of the device 1.

FIGS. 8A-8B show an additional embodiment wherein a portion of the upper edge U is curved downward sharply to intersect the lower edge L as shown. A curved portion is provided between the outside edge O and upper edge U.

FIGS. 9A-9B show an embodiment of the invention wherein an overall length of the upper edge U and lower edge L are extended. Various decorations adorn the decorative side D of the device 1 as shown.

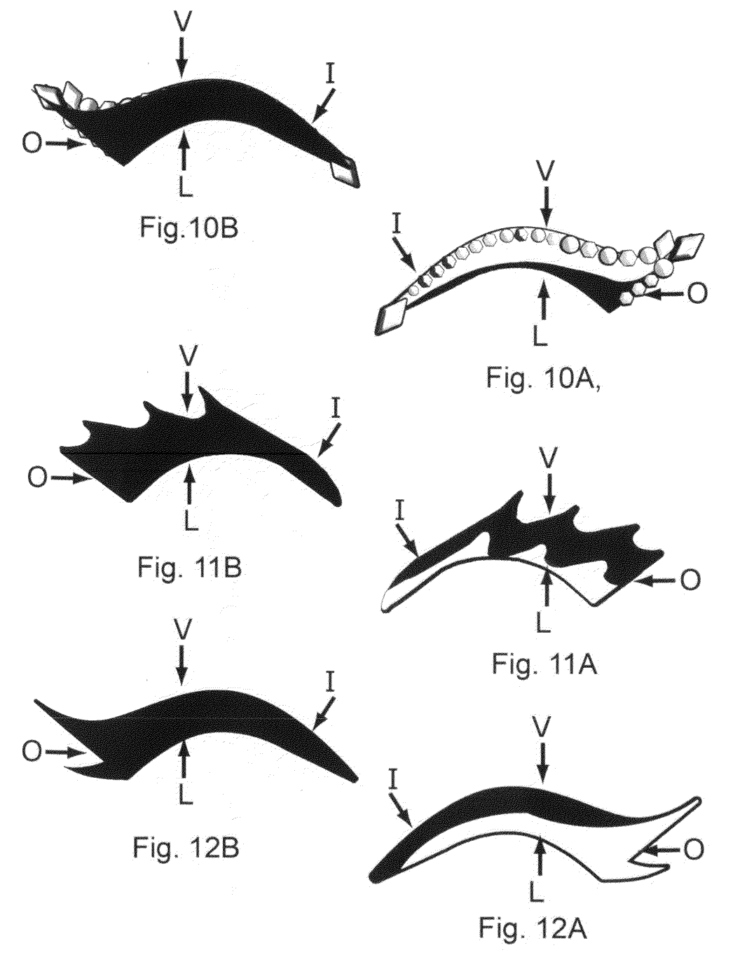

FIGS. 10A-10B show an embodiment wherein the outer edge O is shorter than in previous embodiments. The upper edge U and lower edge L are elongated as shown. Various decorations adorn the decorative side D of the device 1 as shown.

FIGS. 11A-11B depicts an embodiment of the invention 1 wherein undulations are formed along the upper edge U substantially near the outer edge O. A printed pattern is provided on the decorative side as shown.

FIGS. 12A-12B shows an embodiment of the invention wherein the outer edge O includes a flaming pattern formed therein. A printed pattern adorns the decorative side of the device 1 as shown.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A decorative upper eyelid device consisting of:
a strip of adhesive, said adhesive having an upper edge formed in a first shape and having a first and second end, a lower edge formed in a second shape and having a first and second end, an inner edge formed in a third shape by an intersection of the first end of the upper edge with the first end of the lower edge and, an outside edge formed between the second end of the upper edge and the second end of the lower edge, said decorative eyeliner device including an exposed side opposite an adhering side, said exposed side including a decoration.

2. The decorative upper eyelid device of claim 1 wherein said decoration on the exposed side consists of one or more selected from a group consisting of a printed pattern, glitter, foil, paper, rhinestones, synthetic or genuine gems, stones, crystals, plastic, metal and acrylic decorative items and feathers.

3. The decorative eyelid device of claim 1 wherein said upper edge is formed having one or more shapes selected from a group consisting of a concave portion, a convex portion, and undulations.

4. The decorative eyelid device of claim 1 wherein said lower edge is concave in shape.

5. The decorative eyelid device of claim 1 wherein said inner edge is one of a sharp or rounded point.

6. The decorative eyelid device of claim 1 wherein the outer edge is formed having one or more shapes selected from a group consisting of a single straight edge extending between the upper and lower edges, two straight edges intersecting one another at an angle and extending between the upper and lower edges, and flame shaped elements.

7. An eyelid covering comprising:
a strip of adhesive having an inner surface that adheres to an upper portion of an eyelid of a wearer, said strip of adhesive having an outer surface opposite the inner surface,
an upper edge of said strip of adhesive formed in a convex shape, a lower edge formed in a concave shape and intersecting said upper edge to form an inner edge, an outer edge formed between the upper and lower edges and opposite the inner edge and,
a decorative covering formed atop at least a portion of the outer surface of the strip of adhesive.

8. The eyelid covering of claim 7 wherein said decorative covering consists of one or more selected from a group consisting of a printed pattern, glitter, foil, paper, rhinestones, synthetic or genuine gems, stones, crystals, plastic, metal and acrylic decorative items and feathers.

9. The eyelid covering of claim 7 wherein said upper edge is formed having one or more shapes selected from a group consisting of a concave portion, a convex portion, and undulations.

10. The eyelid covering of claim 7 wherein said lower edge is concave in shape.

11. The eyelid covering of claim 7 wherein said inner edge is one of a sharp or rounded point.

12. The eyelid covering of claim 7 wherein the outer edge is formed having one or more shapes selected from a group consisting of a single straight edge extending between the upper and lower edges, two straight edges intersecting one another at an angle and extending between the upper and lower edges, and flame shaped elements.

13. A method for creating an eyelid covering including:
providing a sheet of adhesive having a front side and a back side each side exhibiting adhering properties;
cutting the sheet of adhesive into a shape having an upper edge formed in a convex shape, a lower edge formed in a concave shape and intersecting said upper edge to form an inner edge, an outer edge formed between the upper and lower edges and opposite the inner edge; and,
forming a decorative covering atop at least a portion of the outer surface of the strip of adhesive.

14. The method of claim 13 wherein forming a decorative covering atop at least a portion of the outer surface of the strip of adhesive consists of attaching one or more selected from a group consisting of a printed pattern, glitter, foil, paper, rhinestones, synthetic or genuine gems, stones, crystals, plastic, metal and acrylic decorative items and feathers.

15. The method of claim 13 wherein said upper edge is formed having one or more shapes selected from a group consisting of a concave portion, a convex portion, and undulations.

16. The method of claim 13 wherein said lower edge is formed concave in shape.

18. The method of claim 13 wherein said inner edge is formed in a sharp or rounded point.

19. The method of claim 13 wherein the outer edge is formed having one or more shapes selected from a group consisting of a single straight edge extending between the upper and lower edges, two straight edges intersecting one another at an angle and extending between the upper and lower edges, and flame shaped elements.
